(19) United States
(12) Patent Application Publication
(10) Pub. No.: US 2025/0070184 A1
(43) Pub. Date: Feb. 27, 2025

(54) METAL ADDITIVES FOR MANGANESE DIOXIDE CATHODES

(71) Applicant: Energizer Brands, LLC, St. Louis, MO (US)

(72) Inventor: Weiwei Huang, Westlake, OH (US)

(21) Appl. No.: 18/813,329

(22) Filed: Aug. 23, 2024

Related U.S. Application Data
(60) Provisional application No. 63/578,266, filed on Aug. 23, 2023.

(51) Int. Cl. H01M 4/62; H01M 4/02; H01M 4/505; H01M 6/16; H01M 10/0567

(52) U.S. Cl. CPC H01M 4/628; H01M 4/505; H01M 6/168; H01M 10/0567; H01M 2004/028; H01M 2300/0025

(57) ABSTRACT

Cathodes and electrochemical cells are provided, wherein a barium, bismuth, or nickel additive is included to increase the stability of manganese dioxide at high voltage. The metal additives provided herein improve the performance of electrochemical cells.

### CROSS REFERENCE TO RELATED APPLICATIONS

This application claims the benefit of and priority to U.S. Provisional Application No. 63/578,266, filed Aug. 23, 2023, which is hereby incorporated by reference in its entirety.

### BACKGROUND

Manganese dioxide, particularly in the form of electrolytic manganese dioxide (EMD), is widely used as a cathode material in commercial batteries due to its low cost, low toxicity, and relatively high reduction potential. However, at high voltages and alkaline conditions, manganese dioxide (MnO₂) is unstable in aqueous solutions and deteriorates to form permanganate (MnO₄⁻) or manganate (MnO₄²⁻). This reduces the performance and lifespan of manganese dioxide batteries, particularly at high voltages.

There remains a need for cathode formulations with improved MnO₂ stability in the presence of alkaline electrolytes for batteries with increased performance and lifespan at high voltage. The additives disclosed herein address these limitations by reducing the solubility of MnO₂ at high voltages in manganese-containing cathodes in alkaline solution.

### BRIEF SUMMARY

An embodiment is a cathode comprising manganese dioxide and a metal additive, wherein the metal additive is selected from the group consisting of:
a) a barium additive;
b) a bismuth additive; and
c) a nickel additive.

An embodiment is an electrochemical cell comprising:
a) a container; and
b) an electrode assembly disposed within the container and comprising a cathode, an anode, a separator located between the cathode and the anode, and an electrolyte solution,
wherein the cathode comprises manganese dioxide,
wherein the cathode and/or the electrolyte comprise a metal additive, wherein the metal additive is selected from the group consisting of:
i) a barium additive;
ii) a bismuth additive; and
iii) a nickel additive.

An embodiment is a method of producing the cathode of any above embodiment, the method comprising blending the metal additive with a cathode mix prior to forming the cathode; said cathode mix comprising manganese dioxide and a conductive material.

A method of producing the electrochemical cell of any above embodiment, the method comprising blending the metal additive with a cathode mix prior to forming the cathode and/or mixing the metal additive with the electrolyte solution.

### BRIEF SUMMARY OF THE DRAWINGS

FIG. 1 shows a Pourbaix diagram of the thermodynamically stable phases of an aqueous manganese system based on pH and voltage potential at 25° C. The boundary between solid manganese dioxide (MnO₂) and soluble manganate (MnO₄²⁻) and permanganate (MnO₄⁻) is shown as the topmost dotted line.

FIG. 2 is a cross-sectional elevational view of an alkaline electrochemical cell of an embodiment.

FIG. 3 shows a graph of open circuit voltage (OCV) decay of electrochemical cells with cathodes containing bismuth, barium, and nickelate additives. A solution of 37% KOH-6% ZnO was used as the electrolyte. The electrochemical cells were stored at 60° C. and OCVs were measured throughout a period of 4 weeks.

### DETAILED DESCRIPTION AND DISCUSSION

Various embodiments now will be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements. Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item. For example, “a metal additive” may refer to two or more metal additives.

Each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths, hundredths, thousandths, ten-thousandths, and hundred-thousandths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 7-10%, 5.1%-9.9%, and 5.01%-9.99%. As another example, “0.00001-1 M” includes 0.00005-0.0001 M and 0.001-0.01 M.

As used herein, “about” in the context of a numerical value or range means within +10% of the numerical value or range recited or claimed.

As used herein, the term “and/or” refers to and encompasses any and all possible combinations of one or more of the associated listed items, as well as the lack of combinations when interpreted in the alternative (“or”).

As used herein, “metal additive” refers to a metal-containing compound which is added to the electrolyte and/or cathode of an electrochemical cell. Examples are metal salts and metal oxides. As used herein, “metal ion” refers to an ion of any element which may be considered a metal, including, but not limited to, metals, transition metals (any element in groups 3-12 of the periodic table, particularly groups 4-11), lanthanides, actinides, alkaline earth metals, and alkali metals. “Metal salt” refers to any salt formed from a metal ion. “Metal oxide” refers to any compound comprising a metal ion and oxygen in an oxidation state of −2. Examples of metals suitable for the metal salts, metal oxides, and metal ions of the current invention include bismuth (Bi), barium (Ba), nickel (Ni), strontium (Sr), and silver (Ag). Metal additives may be anhydrous or hydrates.

As used herein, “anhydrous” refers to a compound which does not contain water.

As used herein, “hydrate” refers to a metal salt that contains water molecules combined in a definite ratio that are bound to a metal center or have crystallized with the metal complex. For example, barium chloride can be used in an anhydrous form with the chemical formula BaCl₂ or can be used in the form of a hydrate, such as barium chloride dihydrate which contains two water molecules for each barium ion and has the chemical formula BaCl₂·2H₂O.

As used herein, a “barium additive” refers to a metal additive containing barium, which include barium salts and barium oxide. Barium salts include but are not limited to barium sulfate (BaSO₄), barium hydroxide (Ba(OH)₂), barium chloride (BaCl₂), barium acetate (Ba(CH₃CO₂)₂), barium carbonate (BaCO₃), barium nitrate (Ba (NO₃)₂), barium manganate (BaMnO₄), barium dibismuth hexoxide (BaBi₂O₆), and barium bismuthate (BaBiO₃).

As used herein, a “bismuth additive” refers to a metal additive containing bismuth, which include bismuth salts and bismuth oxides. Bismuth salts include but are not limited to bismuth sulfate (Bi₂(SO₄)₃), bismuth hydroxide (Bi(OH)₃), bismuth chloride (BiCl₃), bismuth acetate (Bi(CH₃CO₂)₃), bismuth subcarbonate ((BiO)₂CO₃), bismuth nitrate (Bi(NO₃)₃), lithium bismuthate (LiBiO₃), sodium bismuthate (NaBiO₃), potassium bismuthate (KBiO₃), silver bismuthate (AgBiO₃), and zinc bismuthate (ZnBi₂O₆). Bismuth oxides include bismuth trioxide (Bi₂O₃) and bismuth pentoxide (Bi₂O₅).

As used herein, a “nickel additive” refers to a metal additive containing nickel, which include nickel salts and nickelates. Nickel additives include but are not limited to nickel oxide (NiO) and nickel oxyhydroxide (NiOOH).

As used herein a “nickelate” refers to a metal salt containing a nickelate anion. As used herein a “nickelate anion” refers to a negatively charged species containing nickel and oxygen (e.g., a nickel oxide). A nickelate anion can contain one or more nickel atoms and two or more oxygen atoms. The nickel atom in a nickelate can be in a +1, +2, +3, or +4 oxidation state and multiple nickel atoms can be present in mixed oxidation states. A nickelate compound can include any cation known in the art including alkali metals, alkaline earth metals, lanthanide metals and transition metals (e.g., silver). Nickelates include beta-nickelate, which can be prepared by the delithiation of LiNiO₂ (e.g., beta-delithiated nickelate).

As used herein, “improvement” with respect to manganese dioxide stability means that less manganese dioxide is converted into soluble manganese species over time. Soluble manganese species may be measured in the electrolyte by inductively coupled plasma mass spectroscopy (ICP-MS) or by any other technique known in the art. Generally, an “improvement” of a property or metric of performance of a material or electrochemical cell means that the property or metric of performance differs (compared to that of a different material or electrochemical cell) in a manner that a user or manufacturer of the material or cell would find desirable (i.e. costs less, lasts longer, provides more power, more durable, easier or faster to manufacture etc.).

As used herein, “soluble manganese species” refer to manganese salts which are dissolved in the electrolyte, which include permanganate (MnO₄⁻) and manganate (MnO₄²⁻) ions.

As used herein, “open circuit voltage (OCV)” refers to the difference in electrochemical potential between the cathode and the anode of an electrochemical cell when not connected to any load in a circuit. An “initial” OCV refers to an OCV reading of an electrochemical cell or the cathode potential vs. a zinc reference electrode at room temperature before discharge and before incubation at elevated temperature for a period of time. In some embodiments, the electrochemical cell or cathode is incubated at room temperature for a period of from one to 30 days prior to discharge, to determine initial service and initial OCV.

As used herein, “specific capacity” refers to the total amount of charge in an electrochemical cell when discharged at a particular rate. This is typically measured in ampere hours.

As used herein, “run-time” refers to the length of time that an electrochemical cell will be able to provide a certain level of charge.

An embodiment is a cathode comprising manganese dioxide and a metal additive, wherein the metal additive is selected from the group consisting of:
a) a barium additive;
b) a bismuth additive; and
c) a nickel additive.

In an embodiment, the metal additive is a barium additive and comprises an anion selected from the group consisting of a sulfate, a hydroxide, an oxide, a chloride, an acetate, a carbonate, a nitrate, a manganate, or a bismuth oxyanion. In an embodiment, the metal additive is a bismuth additive and comprises an anion selected from the group consisting of a sulfate, a hydroxide, an oxide, a chloride, an acetate, or a nitrate. In an embodiment the metal additive comprises nickel, and the nickel additive is a nickelate, an oxide, or an oxyhydroxide.

In an embodiment, the nickel additive comprises nickel dioxide, nickel oxide, or nickel oxyhydroxide. In an embodiment, the metal additive comprises a beta-nickelate, optionally prepared by delithiation of LiNiO₂. Preparation of beta-nickelate is described in U.S. Pat. No. 11,560,321, which is incorporated herein by reference in its entirety.

In an embodiment, the metal additive is selected from the group consisting of barium sulfate (BaSO₄), barium hydroxide (Ba(OH)₂), barium chloride (BaCl₂), bismuth oxide (Bi₂O₃), beta-delithiated nickelate, and silver nickel (III) dioxide (AgNiO₂).

In an embodiment, the cathode comprises the metal additive in a concentration of 0.1 wt %-50 wt %, 0.5 wt %-40 wt %, 1 wt %-30 wt %, 1 wt %-20 wt %, 1 wt %-15 wt %, 1 wt %-10 wt %, 1 wt %-5 wt %, 1 wt %-4 wt %, 1 wt %-3 wt %, 1 wt %-2 wt %, 2 wt %-4 wt %, or 3 wt %-4 wt %. In an embodiment, the cathode comprises the metal additive in a concentration of at least, at most, or about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 wt %, or within a range defined by any two of these values.

In an embodiment, the manganese dioxide comprises electrolytic manganese dioxide (EMD) or chemical manganese dioxide (CMD).

In an embodiment, at least a portion of the manganese dioxide has been treated with an oxidizing agent. In an embodiment, the oxidizing agent is an acid. In an embodiment, the oxidizing agent is sulfuric acid or nitric acid. In an embodiment, the oxidizing agent comprises persulfate, hypochlorite, chlorite, permanganate, or ozone. In an embodiment, the oxidizing agent comprises sodium persulfate. In an embodiment, the manganese dioxide is treated with the oxidizing agent without the presence of the metal additive and then the metal additive is added to the treated manganese dioxide or the cathode. In an embodiment, the manganese dioxide is treated with the oxidizing agent in the presence of the metal additive, and then the treated manganese dioxide is added to the cathode. The cathode may contain additional metal additive. In an embodiment, the cathode comprises manganese dioxide which has been treated with the oxidizing agent and untreated manganese dioxide.

In an embodiment, the manganese dioxide comprises from 0.1 to 99.9% by weight manganese dioxide which has been treated with the oxidizing agent, and from 99.9% to 0.1% by weight manganese dioxide which is untreated.

In an embodiment, the manganese dioxide of the cathode is more stable than an otherwise identical cathode which lacks the metal additive.

An embodiment is an electrochemical cell comprising
a) a container; and
b) an electrode assembly disposed within the container and comprising the cathode of any above embodiment, an anode, a separator located between the cathode and the anode, and an electrolyte solution.

In an embodiment, the electrochemical cell is an alkaline electrochemical cell, and the electrolyte solution is an alkaline electrolyte solution.

In an embodiment, the metal additive is dissolved in the electrolyte solution. In an embodiment, the electrolyte solution is saturated with the metal additive. In an embodiment, the metal additive has a concentration of 0.0001-1 M. In an embodiment, the metal additive has a concentration of at least, at most, or about 0.0001, 0.0005, 0.001, 0.005, 0.01, 0.05, 0.1, 0.2, 0.3, 0.4, 0.5, 0.6, 0.7, 0.8, 0.9, or 1 M, or within a range defined by any two of these values.

In an embodiment, the electrolyte solution comprises potassium hydroxide (KOH), sodium hydroxide (NaOH), lithium hydroxide (LiOH), magnesium hydroxide (Mg(OH)₂), calcium hydroxide (Ca(OH)₂), magnesium perchlorate (Mg(ClO₄)₂), magnesium chloride (MgCl₂), or magnesium bromide (MgBr₂). In an embodiment, the electrolyte comprises 20-54% KOH. In an embodiment, the electrolyte comprises zinc oxide (ZnO).

In an embodiment, the anode comprises an active material selected from the group consisting of zinc, magnesium, aluminum, and silicon.

In an embodiment, a concentration of soluble manganese measured in the electrolyte after a period of time is less than that of an otherwise identical electrochemical cell which lacks the metal additive. In an embodiment, the period of time is 1 day, 2 days, 3 days, 4 days, 5 days, 6 days, 7 days, 2 weeks, 3 weeks, 4 weeks, 2 months, 3 months, 4 months, 5 months, 6 months, 7 months, 8 months, 9 months, 10 months, 11 months or 1 year. In an embodiment, the concentration of soluble manganese in the electrolyte is measured after incubation at a temperature. In an embodiment, the temperature is at least 20° C., at least 25° C., at least 30° C., at least 35° C., at least 40° C., at least 45° C., at least 50° C., at least 55° C., at least 60° C., at least 65° C., at least 70° C., at least 75° C., at least 80° C., at least 85° C., at least 90° C., or at least 95° C.

In an embodiment, the concentration of soluble manganese measured after incubation at 60° C. for 1 week is less than 10 ppm, less than 5 ppm, less than 4 ppm, less than 3 ppm, less than 2 ppm, less than 1.5 ppm, less than 1 ppm, less than 0.9 ppm, less than 0.8 ppm, less than 0.7 ppm, less than 0.6 ppm, or less than 0.5 ppm.

In an embodiment, the electrochemical cell has an initial open circuit voltage of at least 1.5 V. In an embodiment, the initial open circuit voltage of the electrochemical cell is 1.5 V-2.0 V, 1.55 V-2.0 V, 1.6 V-2.0 V, 1.65 V-2.0 V, or 1.6 V-1.7 V, or is 1.5 V, 1.55 V, 1.6 V, 1.65 V, 1.7 V, 1.8 V, 1.9 V, or 2.0 V. In an embodiment, the metal additive comprises nickel and the electrochemical cell has an initial open circuit voltage of at least 1.6 V, at least 1.61 V, at least 1.62 V, at least 1.63 V, at least 1.64 V, or at least 1.65 V.

In an embodiment, an open circuit voltage of 1.6 V is maintained for at least 5 days, at least 10 days, at least 15 days, at least 20 days, at least 25 days, at least 30 days, at least 60 days, or at least 90 days.

In an embodiment, the electrochemical cell is a primary, or disposable, cell. In an embodiment, the electrochemical cell is a secondary, rechargeable, cell.

An embodiment is a method of producing the cathode of any above embodiment, the method comprising blending the metal additive with a cathode mix prior to forming the cathode; said cathode mix comprising manganese dioxide and a conductive material.

An embodiment is a method of producing the electrochemical cell of any above embodiment, the method comprising blending the metal additive with a cathode mix prior to forming the cathode and/or mixing the metal additive with the electrolyte or electrolyte solution.

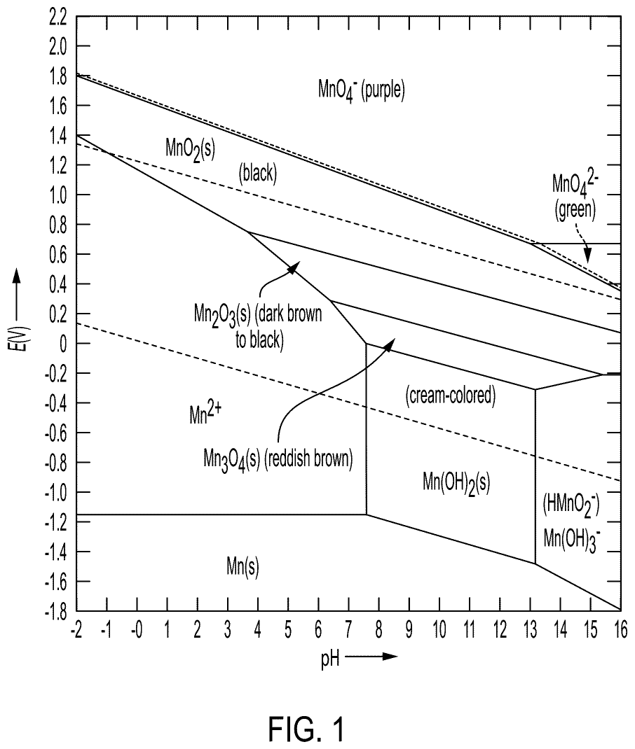

Manganese dioxide (MnO₂), an inexpensive, earth-abundant, and non-toxic compound, has become a popular cathode material for commercial batteries. For various energy storage devices, electrolytic manganese dioxide (EMD) produced by electrowinning is typically the active component of the cathode, which can be used in alkaline, lithium, and sodium batteries. EMD can be used for secondary batteries (e.g., rechargeable batteries) and is likely to remain a practical material for energy storage, particularly during the global transition from fossil fuels to renewable energy sources. However, a challenge for batteries containing manganese dioxide is the stability of MnO₂ in aqueous solutions, which decomposes into manganate (MnO₄²⁻) or permanganate (MnO₄) at conditions with high pH and/or high voltage. The decomposition can be visually observed as discoloration. The Pourbaix diagram seen in FIG. 1 shows the electrochemical stability of MnO₂, which forms green MnO₄²⁻ in solution at pH>13 and purple MnO₄⁻ in solution at high voltage potentials. This poses difficulty for alkaline batteries containing high pH (alkaline) electrolytes, and the deterioration of MnO₂ decreases the performance and lifespan of batteries.

There is a need for improved cathode formulations which maintain stability and decrease the solubility of MnO₂ for extended periods of time at high voltage potentials in alkaline solution. Cathode materials with high voltage potentials and enhanced EMD stability would be beneficial for both primary and secondary batteries.

Previous attempts to address the stability of EMD and reduce manganese solubility have included coating, the addition of dopants, and acid washing. U.S. Pat. No. 8,303,840, which is incorporated herein by reference in its entirety, discloses EMD with normal potential treated with acid to provide increased open circuit voltages.

U.S. Pat. No. 8,734,992, which is incorporated herein by reference in its entirety, claims EMD with high voltage potential (e.g., at least 310 mV) produced by electrolysis in an aqueous solution of sulfuric acid. However, the disclosed acid wash treatments have admittedly not solved the issue of deterioration in alkaline electrolytes at potentials exceeding 400 mV.

Additionally, U.S. Pat. No. 10,804,536, which is incorporated herein by reference in its entirety, teaches doping to increase the stability of chemical manganese dioxide (CMD) cathode materials, which involves replacing a portion of Mn with at least one alternative element. There remains a need to increase the stability of batteries using manganese dioxide as the cathode material, including those with EMD cathodes to improve performance and longevity, ideally without complicating the fabrication process. It should be known the metal additives disclosed herein are not dopants, but can be added to cathode mixes or electrolyte solution after the manganese dioxide active component of the cathode has already been prepared.

Disclosed herein, metal additives, including barium-, bismuth-, and nickel-containing additives provide cathodes with improved manganese dioxide stability at high voltages in alkaline solutions. Reduced Mn solubility and discoloration were observed in electrochemical cells with the metal additives in the cathode or electrolyte solution. High open circuit voltages were maintained for electrochemical cells with the metal additives in the cathodes over extended periods of time.

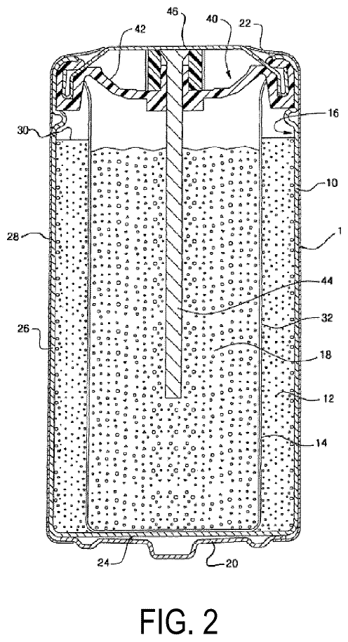

The embodiments will be better understood by reference to FIG. 2 which shows a cylindrical cell 1 in elevational cross-section, with the cell having a nail-type or bobbin-type construction and dimensions comparable to a conventional LR6 (AA) size alkaline cell, which is particularly well-suited to the embodiments. However, it is to be understood that cells according to the embodiments can have other sizes and shapes, such as a prismatic or button-type shape; and electrode configurations, as known in the art. The materials and designs for the components of the electrochemical cell illustrated in FIG. 2 are for the purposes of illustration, and other materials and designs may be substituted. Moreover, in certain embodiments, the cathode and anode materials may be coated onto a surface of a separator and/or current collector and rolled to form a “jelly roll” configuration.

In FIG. 2, an electrochemical cell 1 is shown, including a container or can 10 having a closed bottom end 24, a top end 22 and sidewall 26 there between. The closed bottom end 24 includes a terminal cover 20 including a protrusion. The can 10 has an inner wall 16. In the embodiment, a positive terminal cover 20 is welded or otherwise attached to the bottom end 24. In one embodiment, the terminal cover 20 can be formed with plated steel for example with a protruding nub at its center region. Container 10 can be formed of a metal, such as steel, preferably plated on its interior with nickel, cobalt and/or other metals or alloys, or other materials, possessing sufficient structural properties that are compatible with the various inputs in an electrochemical cell. A label 28 can be formed about the exterior surface of container 10 and can be formed over the peripheral edges of the positive terminal cover 20 and negative terminal cover 46, so long as the negative terminal cover 46 is electrically insulated from container 10 and positive terminal 20.

Disposed within the container 10 are a first electrode 18 and second electrode 12 with a separator 14 therebetween. First electrode 18 is disposed within the space defined by separator 14 and closure assembly 40 secured to open end 22 of container 10. Closed end 24, sidewall 26, and closure assembly 40 define a cavity in which the electrodes of the cell are housed.

Closure assembly 40 comprises a closure member 42 such as a gasket, a current collector 44 and conductive terminal 46 in electrical contact with current collector 44. Closure member 42 preferably contains a pressure relief vent that will allow the closure member to rupture if the cell's internal pressure becomes excessive. Closure member 42 can be formed from a polymeric or elastomer material, for example Nylon-6,6, an injection-moldable polymeric blend, such as polypropylene matrix combined with poly (phenylene oxide) or polystyrene, or another material, such as a metal, provided that the current collector 44 and conductive terminal 46 are electrically insulated from container 10 which serves as the current collector for the second electrode 12. In the embodiment illustrated, current collector 44 is an elongated nail or bobbin-shaped component. Current collector 44 is made of metal or metal alloys, such as copper or brass, conductively plated metallic or plastic collectors or the like. Other suitable materials can be utilized. Current collector 44 is inserted through a preferably centrally located hole in closure member 42.

First electrode 18 is preferably a negative electrode or anode. The negative electrode includes a mixture of one or more active materials, an electrically conductive material, solid zinc oxide, and a surfactant. The negative electrode can optionally include other additives, for example a binder or a gelling agent, and the like.

Zinc is an example main active material for the negative electrode of the embodiments. Mercury and magnesium may also be used. Preferably, the volume of active material utilized in the negative electrode is sufficient to maintain a desired particle-to-particle contact and a desired anode to cathode (A: C) ratio.

Particle-to-particle contact should be maintained during the useful life of the battery. If the volume of active material in the negative electrode is too low, the cell's voltage may suddenly drop to an unacceptably low value when the cell is powering a device. The voltage drop is believed to be caused by a loss of continuity in the conductive matrix of the negative electrode. The conductive matrix can be formed from undischarged active material particles, conductive electrochemically formed oxides, or a combination thereof. A voltage drop can occur after oxide has started to form, but before a sufficient network is built to bridge between all active material particles present.

Zinc suitable for use in the embodiments may be purchased from a number of different commercial sources under various designations, such as BIA 100, BIA 115. Umicore S. A., Brussels, Belgium is an example of a zinc supplier. In a preferred embodiment, the zinc powder generally has 25 to 40 percent fines less than 75 μm, and preferably 28 to 38 percent fines less than 75 μm. Generally lower percentages of fines will not allow desired DSC service to be realized and utilizing a higher percentage of fines can lead to increased gassing. A correct zinc alloy is needed in order to reduce negative electrode gassing in cells and to maintain test service results.

A surfactant that is either a nonionic or anionic surfactant, or a combination thereof is present in the negative electrode. It has been found that anode resistance is increased during discharge by the addition of solid zinc oxide alone, but is mitigated by the addition of the surfactant. The addition of the surfactant increases the surface charge density of the solid zinc oxide and lowers anode resistance as indicated above. Use of a surfactant is believed to aid in forming a more porous discharge product when the surfactant adsorbs on the solid zinc oxide. When the surfactant is anionic, it carries a negative charge and, in alkaline solution, surfactant adsorbed on the surface of the solid zinc oxide is believed to change the surface charge density of the solid zinc oxide particle surfaces. The adsorbed surfactant is believed to cause a repulsive electrostatic interaction between the solid zinc oxide particles. It is believed that the surfactant reduces anode resistance increase caused by the addition of solid zinc oxide because the adsorbed surfactant on solid zinc oxide results in enhanced surface charge density of solid zinc oxide particle surface. The higher the BET surface area of solid zinc oxide, the more surfactant can be adsorbed on the solid zinc oxide surface.

One example surfactant is DISPERBYK-190 from BYK-Chemic GmbH of Wesel, Germany. The surfactant is present in an amount sufficient to disperse the solid zinc oxide, preferably about 0.00064 to about 0.20 weight percent or more, based on the total weight of the negative electrode. DISPERBYK-190 is believed to be a solution including a water soluble, high molecular weight block copolymer including one or more functional groups, believably at least two different types of functional groups. The surfactant has an anionic/nonionic character due to the respective functional groups thereof. It is further believed that the number average molecular weight of a block copolymer DISPERBYK-190 is greater than 1000 measured utilizing gel permeation chromatography. Water solubility may be offset by the presence of a hydrophobic component if present in the electrode composition. In one embodiment, the surfactant is utilized in an amount from about 10 to about 100 ppm and preferably from about 15 to about 50 ppm of zinc utilized in the negative electrode. It is believed that DISPERBYK-190 does not contain any organic solvents and is, therefore, suitable for aqueous systems. DISPERBYK-190 has an acid value in mg KOH/g of 10 and a density of 1.06 g/ml at 20° C.

The aqueous electrolyte may be acidic or preferably alkaline. When alkaline, the aqueous electrolyte comprises an alkaline metal hydroxide such as potassium hydroxide (KOH), sodium hydroxide (NaOH), or the like, or mixtures thereof. Potassium hydroxide is preferred. The alkaline electrolyte used to form the gelled electrolyte of the negative electrode contains the alkaline metal hydroxide in an amount from about 26 to about 36 weight percent, for example from about 26 to about 32 weight percent, and specifically from about 26 to about 30 weight percent based on the total weight of the alkaline electrolyte. Interaction takes place between the negative electrode alkaline metal hydroxide and the added solid zinc oxide, and it has been found that lower alkaline metal hydroxide improves DSC service. Electrolytes which are less alkaline are preferred, but can lead to rapid electrolyte separation of the anode. Increase of alkaline metal hydroxide concentration creates a more stable anode, but can reduce DSC service. Metal additives may be added to the electrolyte. The metal additives in the electrolyte may be saturated or have a concentration of 0.0001-1 M.

A gelling agent is preferably utilized in the negative electrode as is well known in the art, such as a crosslinked polyacrylic acid, such as Carbopol® 940, which is available from Noveon, Inc. of Cleveland, Ohio, USA. Carboxymethylcellulose, polyacrylamide and sodium polyacrylate are examples of other gelling agents that are suitable for use in an alkaline electrolyte solution. Gelling agents are desirable in order to maintain a substantially uniform dispersion of zinc and solid zinc oxide particles in the negative electrode. The amount of gelling agent present is chosen so that lower rates of electrolyte separation are obtained and anode viscosity in yield stress are not too great which can lead to problems with anode dispensing.

Other components which may be optionally present within the negative electrode include, but are not limited to, gassing inhibitors, organic or inorganic anticorrosive agents, plating agents, binders or other surfactants. Examples of gassing inhibitors or anticorrosive agents can include indium salts, such as indium hydroxide, perfluoroalkyl ammonium salts, alkali metal sulfides, etc. In one embodiment, dissolved zinc oxide is present preferably via dissolution in the electrolyte, in order to improve plating on the bobbin or nail current collector and to lower negative electrode shelf gassing. The dissolved zinc oxide added is separate and distinct from the solid zinc oxide present in the anode composition. Levels of dissolved zinc oxide in an amount of about 1 weight percent based on the total weight of the negative electrode electrolyte are preferred in one embodiment. The soluble or dissolved zinc oxide generally has a BET surface area of about 4 m2/g or less measured utilizing a Tristar 3000 BET specific surface area analyzer from Micrometrics having a multi-point calibration after the zinc oxide has been degassed for one hour at 150° C.; and a particle size D50 (mean diameter) of about 1 micron, measured using a CILAS particle size analyzer as indicated above. In a further embodiment, sodium silicate in an amount of about 0.3 weight percent based on the total weight of the negative electrode electrolyte is preferred in the negative electrode in order to substantially prevent cell shorting through the separator during cell discharge.

The negative electrode can be formed in a number of different ways as known in the art. For example, the negative electrode components can be dry blended and added to the cell, with alkaline electrolyte being added separately or, as in a preferred embodiment, a pre-gelled negative electrode process is utilized.

In one embodiment, the zinc and solid zinc oxide powders, and other optional powders other than the gelling agent, are combined and mixed. Afterwards, the surfactant is introduced into the mixture containing the zinc and solid zinc oxide. A pre-gel comprising electrolyte, soluble zinc oxide and gelling agent, and optionally other liquid components, are introduced to the surfactant, zinc and solid zinc oxide mixture which are further mixed to obtain a substantially homogenous mixture before addition to the cell. Alternatively, in a further preferred embodiment, the solid zinc oxide is predispersed in a negative electrode pre-gel comprising the electrolyte, gelling agent, soluble zinc oxide and other desired liquids, and blended, such as for about 15 minutes. The solid zinc oxide and surfactant are then added and the negative electrode is blended for an additional period of time, such as about 20 minutes. The amount of gelled electrolyte utilized in the negative electrode is generally from about 25 to about 35 weight percent, and for example, about 32 weight percent based on the total weight of the negative electrode. Volume percent of the gelled electrolyte may be about 70% based on the total volume of the negative electrode.

In addition to the aqueous electrolyte absorbed by the gelling agent during the negative electrode manufacturing process, an additional quantity of an aqueous solution of alkaline metal hydroxide, i.e., “free electrolyte”, may also be added to the cell during the manufacturing process. The free electrolyte may be incorporated into the cell by disposing it into the cavity defined by the positive electrode or negative electrode, or combinations thereof. The method used to incorporate free electrolyte into the cell is not critical provided it is in contact with the negative electrode, positive electrode, and separator. In one embodiment, free electrolyte is added both prior to addition of the negative electrode mixture as well as after addition. In one embodiment, about 0.97 grams of 29 weight percent KOH solution is added to an LR6 type cell as free electrolyte, with about 0.87 grams added to the separator lined cavity before the negative electrode is inserted. The remaining portion of the 29 weight percent KOH solution is injected into the separator lined cavity after the negative electrode has been inserted.

This free electrolyte, in an embodiment, will comprise the metal additive, initially, and is the source of metal ions which will adsorb to the manganese dioxide-containing cathode. In an embodiment, the same metal additive present in the free electrolyte is present in the electrolyte solution incorporated into the cathode. In an embodiment, the free electrolyte has a different concentration of metal additive than does the cathode electrolyte solution. In an alternate embodiment, the free electrolyte and the cathode electrolyte solution have the same concentration of the metal additive. In an embodiment, the metal additive present in the free electrolyte is not present in the cathode.

Second electrode 12, also referred to herein as the positive electrode or cathode, includes EMD or CMD as the electrochemically active material. EMD or CMD is present in an amount generally from about 80 to about 92 weight percent and preferably from about 81 to 85 weight percent by weight based on the total weight of the positive electrode, i.e., manganese dioxide, conductive material, positive electrode electrolyte and additives, including the metal additive, if present. The positive electrode is formed by combining and mixing desired components of the electrode followed by dispensing a quantity of the mixture into the open end of the container and then using a ram to mold the mixture into a solid tubular configuration that defines a cavity within the container in which the separator 14 and first electrode 18 are later disposed. Second electrode 12 has a ledge 30 and an interior surface 32 as illustrated in FIG. 2. Alternatively, the positive electrode may be formed by pre-forming a plurality of rings from the mixture comprising EMD or CMD, and optionally, the metal additive, and then inserting the rings into the container to form the tubular-shaped second electrode. The cell shown in FIG. 2 would typically include 3 or 4 rings.

The positive electrode can include other components such as a conductive material, for example graphite, that when mixed with the EMD or CMD provides an electrically conductive matrix substantially throughout the positive electrode. Conductive material can be natural, i.e., mined, or synthetic, i.e., manufactured. In one embodiment, the cells include a positive electrode having an active material or oxide to carbon ratio (O:C ratio) that ranges from about 12 to about 24. In an embodiment, the O:C ratio ranges from about 12-14. Too high of an oxide to carbon ratio increases the container to cathode resistance, which affects the overall cell resistance and can have a potential effect on high rate tests, such as the DSC test, or higher cut-off voltages. Furthermore, the graphite can be expanded or non-expanded. Suppliers of graphite for use in alkaline batteries include Timcal America of Westlake, Ohio; Superior Graphite Company of Chicago, Ill.; and Lonza, Ltd. of Basel, Switzerland. Conductive material is present generally in an amount from about 5 to about 10 weight percent based on the total weight of the positive electrode. Too much graphite can reduce EMD or CMD input, and thus cell capacity; too little graphite can increase container to cathode contact resistance and/or bulk cathode resistance. Other additives can include, for example titanium dioxide, binders such as coathylene, and calcium stearate.

In one embodiment, the positive electrode component (EMD or CMD), conductive material, and metal additive (e.g., barium-, bismuth-, or nickel-containing additive) are mixed together to form a homogeneous mixture. During the mixing process, an electrolyte solution, such as from about 37% to about 40% KOH solution, optionally including the metal additive, is evenly dispersed into the mixture thereby insuring a uniform distribution of the solution throughout the positive electrode materials. The mixture is then added to the container and molded utilizing a ram. Moisture within the container and positive electrode mix before and after molding, and components of the mix are preferably optimized to allow quality positive electrodes to be molded. Mix moisture optimization allows positive electrodes to be molded with minimal splash and flash due to wet mixes, and with minimal spalling and excessive tool wear due to dry mixes, with optimization helping to achieve a desired high cathode weight. Moisture content in the positive electrode mixture can affect the overall cell electrolyte balance and has an impact on high rate testing.

One of the parameters utilized by cell designers characterizes cell design as the ratio of one electrode's electrochemical capacity to the opposing electrode's electrochemical capacity, such as the anode (A) to cathode (C) ratio, i.e., A: C ratio. For an LR6 type alkaline primary cell that utilizes zinc in the negative electrode or anode and MnO₂ in the positive electrode or cathode, the A: C ratio may be greater than 1.32:1, such as greater than 1.34:1, and specifically 1.36:1 for impact molded positive electrodes. The A: C ratio for ring molded positive electrodes can be lower, such as about 1.2:1 to about 1.1:1.

Separator 14 is provided in order to separate first electrode 18 from second electrode 12. Separator 14 maintains a physical dielectric separation of the positive electrode's electrochemically active material from the electrochemically active material of the negative electrode and allows for transport of ions between the electrode materials. In addition, the separator acts as a wicking medium for the electrolyte and as a collar that prevents fragmented portions of the negative electrode from contacting the top of the positive electrode. Separator 14 can be a layered ion permeable, non-woven fibrous fabric. A typical separator usually includes two or more layers of paper. Conventional separators are usually formed either by pre-forming the separator material into a cup-shaped basket that is subsequently inserted under the cavity defined by second electrode 12 and closed end 24 and any positive electrode material thereon, or forming a basket during cell assembly by inserting two rectangular sheets of separator into the cavity with the material angularly rotated 90° relative to each other. Conventional pre-formed separators are typically made up of a sheet of non-woven fabric rolled into a cylindrical shape that conforms to the inside walls of the second electrode and has a closed bottom end.

All of the references cited above, as well as all references cited herein, are incorporated herein by reference in their entireties.

While embodiments have been illustrated and described in detail above, such illustration and description are to be considered illustrative or exemplary and not restrictive. It will be understood that changes and modifications may be made by those of ordinary skill within the scope and spirit of the following claims. In particular, embodiments include any combination of features from different embodiments described above and below.

The embodiments are additionally described by way of the following illustrative non-limiting examples that provide a better understanding of the embodiments and of its many advantages. The following examples are included to demonstrate preferred embodiments. It should be appreciated by those of skill in the art that the techniques disclosed in the examples which follow represent techniques used in the embodiments to function well in the practice of the embodiments, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the embodiments.

### EXAMPLES

### Example 1: Additives to High-Voltage EMD Improve Cathode Stability

In order to develop cathodes for batteries with greater stability at high voltages, various salts were tested as additives in cathode mixes. A high-voltage EMD (S47) was prepared by treating a commercial EMD with persulfate. A 1 M sodium persulfate solution was prepared by dissolving a reagent-grade sodium persulfate in deionized water. 1000 g of a commercial EMD powder supplied by the Energizer plant in Marietta, OH was added to 980 g of 1 M sodium persulfate at room temperature. The EMD solution was heated to 70° C. and stirred for 6 hours, then the supernatant was decanted and the resulting treated EMD was washed several times with 70° C. deionized water until the pH of the supernatant was approximately 2.8. Next, 120 g of 5 wt % NaOH solution was added to the washed EMD to neutralize residual acid generated from the treatment with sodium persulfate. The neutralized EMD was rinsed with deionized water and dried at 70° C. overnight to provide S47 high-voltage EMD.

Cathode mixes were prepared with 92.97 wt % (EMD+additive), 5.09 wt % graphite, 0.2 wt % coathylene, and 1.98 wt % of a KOH solution containing 45% KOH by weight. Various concentrations of bismuth, strontium, barium, or silver salts were tested as additives with the EMD in the cathode mix. Samples of the cathode mixes were pelleted for storage.

An electrolyte solution was prepared by dissolving 6% ZnO in a 37% solution of KOH in water. In polypropylene test tubes, cathode pellets were immersed in the 37% KOH-6% ZnO electrolyte at a 10:1 ratio of electrolyte volume (mL) to cathode weight (g). After storage at 60° C. for 1 week, samples were centrifuged and the amount of soluble Mn species in the liquid was detected by inductively coupled plasma mass spectroscopy (ICP-MS) as a measure of EMD stability, as shown in Table 1.

For the high-voltage EMD without any additives, as seen in lot SS31, 15.6 ppm of soluble Mn was detected from the deterioration of MnO₂. As a control, EMD was used without persulfate treatment (e.g., low-voltage EMD), as seen in lot SS32, which had a significantly lower concentration of soluble Mn at 0.83 ppm than the high-voltage EMD. Two different concentrations of Bi₂O₃, Sr(OH)₂, BaSO₄, AgNiO₂, Ag₂O, BaCl₂·2H₂O, and Ba(OH)₂·8H₂O were tested as additives to the persulfate treated EMD in the cathode mix. The addition of several chemicals significantly reduced soluble Mn concentration, including 13% Bi₂O₃, 7% BaSO₄, 10.7% AgNiO₂, 9.5% BaCl₂·2H₂O, and 9.9% BaOH₂·8H₂O by weight (e.g., additive wt % determined as additive weight/additive weight+EMD weight×100). The most effective additives reduced the soluble Mn concentration to less than 1 ppm, close to the concentration of Mn detected in the low-voltage control in lot SS32.

TABLE 1
Additives in EMD cathode mixes

| | | | Additive | Soluble Mn species |
|---|---|---|---|---|
| Lot # | EMD | Additives | wt % | (ppm) |
| SS17 | S47 | Bi₂O₃ | 2.9% | 13.3 |
| SS18 | S47 | Bi₂O₃ | 13.0% | 1.2 |
| SS19 | S47 | Sr(OH)₂ | 1.2% | 9.5 |
| SS20 | S47 | Sr(OH)₂ | 5.8% | 7.0 |
| SS21 | S47 | BaSO₄ | 1.5% | 7.3 |
| SS22 | S47 | BaSO₄ | 7.0% | 0.8 |
| SS23 | S47 | AgNiO₂ | 2.3% | 5.0 |
| SS24 | S47 | AgNiO₂ | 10.7% | 0.9 |
| SS25 | S47 | Ag₂O | 2.4% | 14.0 |
| SS26 | S47 | Ag₂O | 10.7% | 5.9 |
| SS27 | S47 | BaCl₂•2H₂O | 2.0% | 7.3 |
| SS28 | S47 | BaCl₂•2H₂O | 9.5% | 0.8 |
| SS29 | S47 | Ba(OH)₂•8H₂O | 2.2% | 8.9 |
| SS30 | S47 | Ba(OH)₂•8H₂O | 9.9% | 0.8 |
| SS31 | S47 | none | 0.0% | 15.6 |
| SS32 | untreated EMD | none | 0.0% | 0.83 |

### Example 2: Barium and Bismuth Additives to EMD During Persulfate Treatment

A range of concentrations of BaSO₄ and Bi₂O₃ were tested as additives during the persulfate treatment process of the EMD. In polypropylene test tubes, EMD powder samples were immersed in the 37% KOH-6% ZnO electrolyte at a 10:1 ratio of electrolyte volume (mL) to cathode weight (g). After storage at 60° C. for 1 week, samples were centrifuged and the amount of soluble Mn species in the liquid was detected by ICP-MS as a measure of EMD stability, as shown in Table 2. The addition of both barium and bismuth compounds during the process of persulfate treatment to increase voltage improved the stability of the cathode materials. A control sample without additives had 13.8 ppm soluble Mn species observed after 1 week at 60° C. (S51) as compared to the 1.1 ppm soluble Mn in the sample with 7.0% BaSO₄ added (S54). Higher concentrations of additives provided for less soluble Mn detected. Similar results were observed for BaSO₄ which was milled to have a smaller particle size (S55). Without wishing to be bound by theory, the particle size of the commercially available BaSO₄, which is typically approximately 2 μm, may be fine enough to be effective. A reduction of soluble Mn was also observed for higher weight percentages of Bi₂O₃ where 8.3% reduced soluble Mn to 6.3 ppm (S57) and 13.0% reduced soluble Mn to 3.8 ppm (S58).

TABLE 2
Additives during persulfate treatment of EMD

| Lot # | Additives | Additive wt % | Soluble Mn species (ppm) |
|---|---|---|---|
| S51 | None (control) | None | 13.8 |
| S52 | BaSO₄ (low) | 1.5% | 12.2 |
| S53 | BaSO₄ (med) | 2.9% | 7.4 |
| S54 | BaSO₄ (high) | 7.0% | 1.1 |
| S55 | BaSO₄ (med), | 2.9% | 7.1 |
| | Milled | | |
| S56 | Bi₂O₃ (low) | 2.9% | 15.0 |
| S57 | Bi₂O₃ (med) | 8.3% | 6.3 |
| S58 | Bi₂O₃ (high) | 13.0% | 3.8 |

### Example 3: Soaking Treated EMD KOH—ZnO Solutions Saturated with Ba(OH)₂

EMD stability was also tested through the addition of barium additives to the electrolyte. High-voltage EMD (S47) was prepared and samples were stored in a powder form. The treated EMD was then soaked with electrolyte solutions saturated with Ba(OH)₂ containing 28% KOH-4.4% ZnO or 37% KOH-6.0% ZnO. Additionally, ratios of electrolyte to EMD (mL: gram ratios) were tested from 0.5:1 to 10:1. The amount of soluble Ba and Mn species were detected after storage at 60° C. for 1 week as a measure of EMD stability, as shown in Table 3. Electrolyte: EMD ratios of 10:1 and 5:1 showed enhanced MnO₂ stability with the lowest concentrations of soluble Mn detected. Elevated Ba levels were observed in these samples, but not with samples with less electrolyte relative to EMD, where higher concentrations of Mn species were detected. For the samples with 10:1 or 5:1 electrolyte: EMD, the 37% KOH-6.0% ZnO electrolyte gave reduced Mn species as compared to the 37% KOH-6.0% ZnO.

TABLE 3
Barium additives to the electrolyte

| | | | Ba | Mn |
|---|---|---|---|---|
| | Elyte:EMD | | (ppm) | (ppm) |
| Lot | ratio | Electrolyte | detected | detected |
| SS43 | 10:1 | 28% KOH—4.4% ZnO-sat'ed | 2020.0 | 1.4 |
| | | Ba(OH)₂ | | |
| SS44 | 10:1 | 37% KOH—6.0% ZnO-sat'ed | 5850.0 | 0.8 |
| | | Ba(OH)₂ | | |
| SS61 | 5:1 | 28% KOH—4.4% ZnO-sat'ed | 981.0 | 0.53 |
| | | Ba(OH)₂ | | |
| SS62 | 5:1 | 37% KOH—6.0% ZnO-sat'ed | 4070.0 | 0.45 |
| | | Ba(OH)₂ | | |
| SS63 | 1:1 | 28% KOH—4.4% ZnO-sat'ed | 0.1 | 18.2 |
| | | Ba(OH)₂ | | |
| SS64 | 1:1 | 37% KOH—6.0% ZnO-sat'ed | 3.9 | 38.0 |
| | | Ba(OH)₂ | | |
| SS65 | 0.5:1 | 28% KOH—4.4% ZnO-sat'ed | 0.03 | 26.0 |
| | | Ba(OH)₂ | | |
| SS66 | 0.5:1 | 37% KOH—6.0% ZnO-sat'ed | 0.03 | 56.7 |
| | | Ba(OH)₂ | | |

Without wishing to be bound by theory, the reduced stability of MnO₂ observed with less electrolyte relative to EMD may be related to the ability of the EMD to absorb barium given the low solubility of barium in an aqueous alkaline solution. Ba ions may be adsorbed onto the surface of the EMD via ion exchange, forming a stable EMD surface and preventing the dissolution of high voltage EMD in concentrated KOH. The dissolution of MnO₂ to form soluble manganate in KOH solution, which is deep green is shown in the following reaction:

3MnO₂+(2K⁺+2OH⁻)_{aq}→2MnOOH+(2K⁺+MnO₄²⁻)_{aq}

The increased MnO₂ stability was reflected by a lack of discoloration in samples SS61 and SS62, which had less than 1 ppm soluble Mn detected. In comparison, samples SS63 and SS64 with less additive-containing electrolyte relative to EMD and elevated soluble Mn levels turned deep blue in color.

### Example 4: Nickelate Additives

The effect of nickelate was studied as an additive in cathode mixes. A high-voltage beta-delithiated nickelate was prepared by treating LiNiO₂ in a sulfuric acid solution followed by aging in a KOH solution, as described in U.S. Pat. No. 11,560,321. High-voltage EMD (S47) was prepared and was mixed with various concentrations of the nickelate. In polypropylene test tubes, pelleted EMD samples were immersed in the 37% KOH-6% ZnO electrolyte at a 10:1 ratio of electrolyte volume (mL) to cathode weight (g). After storage at 60° C. for 1 week, samples were centrifuged and the amount of soluble Mn species in the liquid was detected by ICP-MS as a measure of EMD stability, as shown in Table 4. Additionally, the open circuit voltage (OCV) was measured relative to a zinc reference electrode after 1 day of storage at 60° C. For samples with higher concentrations of nickelate, high OCVs were measured up to approximately 1.8V, yet soluble Mn concentrations remained low. For the samples with 50% and 75% of nickelate by weight, the concentration of soluble Mn remained under 1 ppm. At the high voltages of 1.790 and 1.801, the solubility of Mn would be expected to be greater than 5 ppm, indicating the nickelate additive improved the stability of MnO₂ at high voltage.

TABLE 4
Nickelate additives to EMD

| | | OCV (V) 1 day vs. Zn | Soluble Mn |
|---|---|---|---|
| Lot# | Nickelate wt % | ref. | ppm |
| N1 (control) | 0 | 1.618 | 1.14 |
| N2 | 25 | 1.737 | 1.01 |
| N3 | 50 | 1.790 | 0.93 |
| N4 | 75 | 1.801 | 0.96 |

For comparison, an electrochemically charged EMD was tested without the addition of the nickelate, as shown in Table 5. Electrochemically charged EMD was prepared by discharging pellet cathodes using a constant current on a rate of 0.5 mA/g of active material (EMD+nickelate) at room temperature. Plastic flooded half cells with a sufficient quantity of 40% KOH-6% ZnO solution were used as test vehicles with a Luggin capillary zinc reference electrode for measuring the voltage. The same 40% KOH-6% ZnO solution was used as the electrolyte in the reference electrode. Once the voltage reached the specified end points (e.g., 1.700, 1.800, and 1.900V), the cathodes were harvested from the plastic half cells and stored in 37% KOH-6% ZnO solutions at 60° C. for one week.

The electrochemically charged EMD with voltages of 1.8V and 1.9V had 10.2 ppm and 19.0 ppm of soluble Mn, respectively. The expected increase in soluble Mn at higher voltages shows the expected deterioration of MnO₂ of the cathode in alkaline conditions. The cathode fabricated with 50% nickelate₂ (N3), had over 20-fold less soluble Mn, as the electrochemically charged EMD of the same 1.8V potential.

TABLE 5
Electrochemically charged EMD

| Electrochemically charged EMD (V) | Soluble Mn ppm |
|---|---|
| 1.621 | 1.2 |
| 1.700 | 1.2 |
| 1.800 | 10.2 |
| 1.900 | 19.0 |

### Example 5: Long-Term OCV Decay

To study long term stability, cathodes were fabricated with various additives, stored at 60° C., and OCVs were measured at various timepoints for 4 weeks. A high-voltage EMD (S47) was prepared and was mixed with 13% Bi₂O₃, 7% BaSO₄, 10.7% AgNiO₂, or 9.9% Ba(OH)₂·8H₂O form a cathode mix. Both treated and untreated EMDs were tested without any additives for comparison. A 37% KOH-6% ZnO solution was used as the electrolyte.

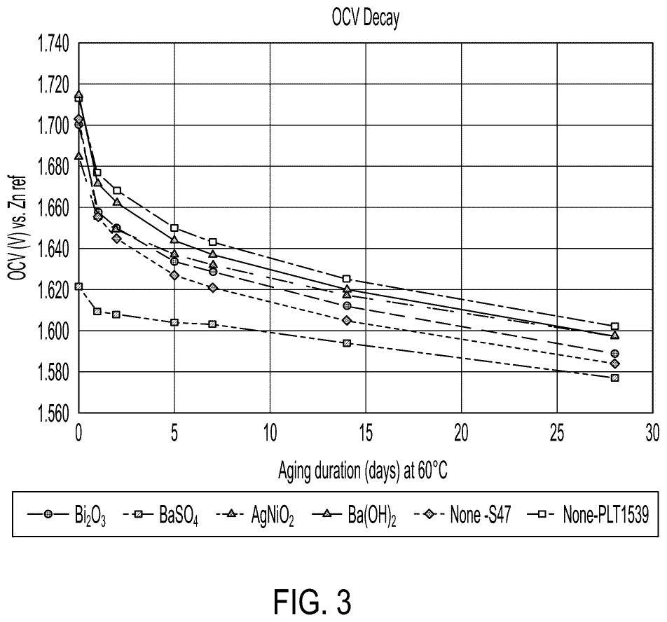

As shown in Table 6 and FIG. 3, OCVs remained higher throughout the month for samples with additives, with BaSO₄ retaining the highest voltage (SS21-1, 1.602V), followed by Ba(OH)₂ (SS30-1, 1.597V), and AgNiO₂, which remained higher than the treated EMD without any additive (SS31-1, 1.584V) and the untreated control EMD (SS32-1, 1.577V). The data indicates barium and silver nickelate additives in particular improved the long-term stability of EMD cathodes at high voltage.

TABLE 6
OCV decay of EMD with additives

| | | OCV | OCV | OCV | OCV | OCV | OCV | OCV | OCV | Total |
|---|---|---|---|---|---|---|---|---|---|---|
| | | at 1 h | at 20 h | at 2 d | at 3 d | at 6 d | at 8 d | at 15 d | at 29 d | decay |
| Lot | Additive | (V) | (V) | (V) | (V) | (V) | (V) | (V) | (V) | (V) |
| SS18-1 | Bi₂O₃ | 1.711 | 1.701 | 1.658 | 1.650 | 1.634 | 1.629 | 1.612 | 1.589 | 0.122 |
| SS22-1 | BaSO₄ | 1.722 | 1.713 | 1.677 | 1.668 | 1.650 | 1.643 | 1.625 | 1.602 | 0.120 |
| SS24-1 | AgNiO₂ | 1.694 | 1.685 | 1.655 | 1.649 | 1.637 | 1.632 | 1.617 | 1.597 | 0.097 |
| SS30-1 | Ba(OH)₂ | 1.723 | 1.715 | 1.672 | 1.662 | 1.644 | 1.637 | 1.620 | 1.597 | 0.126 |
| SS31-1 | None - | 1.714 | 1.703 | 1.655 | 1.645 | 1.627 | 1.621 | 1.605 | 1.584 | 0.130 |
| | treated | | | | | | | | | |
| SS32-1 | None - | 1.623 | 1.621 | 1.609 | 1.608 | 1.604 | 1.603 | 1.594 | 1.577 | 0.046 |
| | untreated | | | | | | | | | |

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A cathode comprising manganese dioxide and a metal additive, wherein the metal additive is selected from the group consisting of:
a) a barium additive;
b) a bismuth additive; and
c) a nickel additive.

2. The cathode of claim 1, wherein
a) the metal additive is a barium additive and comprises an anion selected from the group consisting of a sulfate, a hydroxide, an oxide, a chloride, an acetate, a carbonate, a nitrate, a manganate, and a bismuth oxyanion;
b) the metal additive is a bismuth additive and comprises an anion selected from the group consisting of a sulfate, a hydroxide, an oxide, a chloride, an acetate, and a nitrate; or
c) the metal additive is a nickel additive and the nickel additive is a nickelate, an oxide, or an oxyhydroxide.

3. The cathode of claim 1, wherein the metal additive is the nickel additive, and wherein the nickel additive comprises nickel dioxide, nickel oxide, or nickel oxyhydroxide.

4. The cathode of claim 1, wherein the metal additive is selected from the group consisting of barium sulfate (BaSO₄), barium hydroxide (Ba(OH)₂), barium chloride (BaCl₂), bismuth oxide (Bi₂O₃), beta-delithiated nickelate, and silver nickel (III) dioxide (AgNiO₂).

5. (canceled)

6. (canceled)

7. The cathode of claim 1, wherein at least a portion of the manganese dioxide has been treated with an oxidizing agent.

8. (canceled)

9. (canceled)

10. The cathode of claim 7, wherein the oxidizing agent comprises persulfate, hypochlorite, chlorite, permanganate, or ozone.

11.-14. (canceled)

15. The cathode of claim 1, wherein the manganese dioxide is more stable than an otherwise identical cathode which lacks the metal additive.

16. An electrochemical cell comprising
a) a container; and
b) an electrode assembly disposed within the container and comprising the cathode of claim 1, an anode, a separator located between the cathode and the anode, and an electrolyte solution.

17. An electrochemical cell comprising
a) a container; and
b) an electrode assembly disposed within the container and comprising a cathode, an anode, a separator located between the cathode and the anode, and an electrolyte solution,
wherein the cathode comprises manganese dioxide, and
wherein the cathode and/or the electrolyte comprise a metal additive, wherein the metal additive is selected from the group consisting of:
i) a barium additive;
ii) a bismuth additive; and
iii) a nickel additive.

18. The electrochemical cell of claim 17, wherein
i) the metal additive is a barium additive and comprises an anion selected from the group consisting of a sulfate, a hydroxide, an oxide, a chloride, an acetate, a carbonate, a nitrate, a manganate, or a bismuth oxyanion;
ii) the metal additive is a bismuth additive and comprises an anion selected from the group consisting of a sulfate, a hydroxide, an oxide, a chloride, an acetate, or a nitrate; or
iii) the metal additive is a nickel additive, and the nickel additive is a nickelate, an oxide, or an oxyhydroxide.

19. The electrochemical cell of claim 18, wherein the metal additive is the nickel additive, and wherein the nickel additive comprises nickel dioxide, nickel oxide, or nickel oxyhydroxide.

20. The electrochemical cell of claim 17, wherein the metal additive is selected from the group consisting of barium sulfate (BaSO₄), barium hydroxide (Ba(OH)₂), barium chloride (BaCl₂), bismuth oxide (Bi₂O₃), beta-delithiated nickelate, and silver nickel (III) dioxide (AgNiO₂).

21. (canceled)

22. The electrochemical cell of claim 1, wherein at least a portion of the manganese dioxide has been treated with an oxidizing agent.

23. (canceled)

24. (canceled)

25. The electrochemical cell of claim 22, wherein the oxidizing agent comprises persulfate, hypochlorite, chlorite, permanganate, or ozone.

26. (canceled)

27.-32. (canceled)

33. The electrochemical cell of claim 16, wherein a concentration of soluble manganese measured in the electrolyte after a period of time is less than that of an otherwise identical electrochemical cell which lacks the metal additive; wherein the period of time ranges from 1 day to 1 year.

34. (canceled)

35. The electrochemical cell of claim 33, wherein the concentration of soluble manganese in the electrolyte is measured after incubation at a temperature of at least 20° C.

36.-42. (canceled)

43. The electrochemical cell of claim 1, wherein the electrochemical cell is a primary cell.

44. The electrochemical cell of claim 1, wherein the electrochemical cell is a secondary cell.

45. A method of producing the cathode of claim 1, the method comprising blending the metal additive with a cathode mix prior to forming the cathode; said cathode mix comprising manganese dioxide and a conductive material.

46. A method of producing the electrochemical cell of claim 1, the method comprising blending the metal additive with a cathode mix prior to forming the cathode and/or mixing the metal additive with the electrolyte solution.
